(19) United States
(12) Patent Application Publication
(10) Pub. No.: US 2026/0204994 A1
(43) Pub. Date: Jul. 16, 2026

(54) THREE-MOVER LINEAR MOTOR

(71) Applicant: Dongguan Kede Precision Manufacturing Co., Ltd., Dongguan (CN)

(72) Inventors: YOUWEI TANG, Dongguan (CN); YOUCHUN YAN, Dongguan (CN)

(21) Appl. No.: 19/078,183

(22) Filed: Mar. 12, 2025

(30) Foreign Application Priority Data
Jan. 10, 2025 (CN) 202520052156.8

(51) Int. Cl. H02K 33/18

(52) U.S. Cl. CPC H02K 33/18

(57) ABSTRACT

Disclosed is a three-mover linear motor, including a bracket, a mover assembly and a stator assembly are arranged inside the bracket; the mover assembly is suspended above the stator assembly and performs interlaced reciprocating motion driven by the stator assembly; the mover assembly includes an inner mover and outer movers arranged on both sides of the inner mover, an annular frame is connected between the two outer movers, the annular frame does not come into contact with the inner mover when swinging, and swings along with the swinging of the two outer movers, thereby ensuring that swinging frequencies of the two outer movers are consistent; and a limiting member is connected between the inner mover and any of the outer movers, at least one end of the limiting member is provided with an opening, and the inner mover or the outer movers are rotationally connected in the opening.

### CROSS-REFERENCE TO RELATED APPLICATIONS

This application claims priority to Chinese Patent Application No. 202520052156.8, filed on Jan. 10, 2025, which is hereby incorporated by reference in its entirety.

### TECHNICAL FIELD

The present disclosure belongs to the field of motors, and particularly relates to a three-mover linear motor.

### BACKGROUND

A magnetic levitation swing motor adopts advanced motor technology that utilizes the principles of magnetic field to achieve rotor levitation and swinging. By accurately controlling strength and direction of a stator's magnetic field, swinging angle and speed of a mover can be accurately controlled. Therefore, the magnetic levitation swing motor is widely used in electric tools, such as hair clippers. However, compared to a motor with three movers, each mover needs to swing, and the prior art adopts a same structure for each mover, making swinging of the three movers independent of one another, which not only results in excessive use of internal spare parts and a complex structure of the motor, thereby significantly reducing assembly efficiency, but also increases the resistance encountered by the movers during the swinging, thereby increasing noise and affecting swinging accuracy of the movers.

### SUMMARY

### (1) Technical Problem to be Solved

The present disclosure provides a three-mover linear motor, aiming to solve the problem in the prior art that the motor with three movers has low assembly efficiency and high noise due to a complex internal structure.

### (2) Technical Solution

The present disclosure provides a three-mover linear motor, including a bracket, where a mover assembly and a stator assembly are arranged inside the bracket, and the mover assembly is suspended above the stator assembly and performs interlaced reciprocating motion driven by the stator assembly; the mover assembly includes an inner mover and outer movers respectively arranged on both sides of the inner mover, an integrally die-cast annular frame is connected between the two outer movers, the two outer movers and the annular frame are completely symmetrically arranged in front, rear, left, and right directions, and the inner mover moves back and forth in the annular frame, and a direction of motion of the inner mover is opposite to that of the annular frame;

where a limiting member is connected between a central position above the inner mover and a central position above any of the outer movers, the limiting member is movably and rotationally connected to an inner wall at a top of the bracket, and the limiting member is located between the bracket and the mover assembly; and

the inner mover includes an inner swinging member and an inner magnetic yoke from top to bottom, an inner swinging shaft is arranged on the inner swinging member, and the inner swinging shaft penetrates through the inner swinging member and the inner magnetic yoke in sequence to achieve a fixed connection between them.

Further, each of the outer movers includes an outer magnetic yoke and an outer swinging shaft that are fixedly connected to the annular frame, a third through hole is formed on the outer magnetic yoke, a first mounting column is arranged in a middle above front and rear crossbeams of the annular frame, a second cylindrical hole is formed inside the first mounting column, and the outer swinging shaft passes through the second cylindrical hole and the third through hole in sequence.

Further, both ends of the limiting member are provided with openings, and the outer swinging shaft and the inner swinging shaft are rotationally connected in the openings respectively.

Further, a limiting rod is arranged in a middle of the limiting member, one end of the limiting rod is rotationally connected to the limiting member, and the other end thereof extends upward and is fixedly connected to the bracket.

Further, the mover assembly further includes a magnet set, the magnet set includes a first inner magnet and a second inner magnet that are fixedly connected to the inner magnetic yoke respectively, and a first outer magnet and a second outer magnet that are fixedly connected to the outer magnetic yoke respectively, magnetic poles of the first inner magnet and the first outer magnet are opposite, and magnetic poles of the second inner magnet and the second outer magnet are opposite.

Further, elastic members are compressed between two sides of the inner swinging member in a direction of motion and inner walls of the annular frame.

Further, both sides of the outer mover and the inner mover are provided with spring pieces, and two spring pieces are provided; each of the spring pieces includes an inner spring plate and outer spring plates, and an upper end of the inner spring plate is fixedly connected to the inner mover; second mounting columns are arranged at two ends below left and right crossbeams of the annular frame, upper ends of the outer spring plates are fixedly connected to the second mounting columns, and lower ends of the inner spring plate and the outer spring plates are fixedly connected to the bracket.

Further, a width L2 of each of the outer movers is less than or equal to a width L1 of the inner mover.

Further, the stator assembly includes an iron core, a coil, and a coil frame, where the iron core is arranged in an inverted E-shape and is screwed to the bracket on both sides, the coil frame is sleeved over a middle part of the iron core 1, and the coil is wound around the coil frame.

Compared with the prior art, the present disclosure has the beneficial effects:
The two outer movers are connected via an annular frame, which is integrally die-cast and swings along with the swinging of the inner mover, thereby ensuring swinging frequencies of the two outer movers remain consistent, improving swinging accuracy of the inner mover, greatly reducing a number of spare parts, simplifying the structure and improving assembly efficiency. In addition, a limiting member is connected between the inner mover and any of the outer movers, and at least one end of the limiting member is provided with an opening, and the inner mover or the outer movers are rotationally connected in the opening, thereby reducing impact caused by the movers during swinging in a high speed, greatly reducing the noise and providing a better user experience.

### BRIEF DESCRIPTION OF DRAWINGS

FIG. 1 is an overall structural schematic diagram of the present disclosure.

FIG. 2 is an exploded view of an overall structure of present disclosure.

FIG. 3 is an exploded view of a mover assembly of the present disclosure.

FIG. 4 is a structural schematic diagram of a limiting member of the present disclosure.

FIG. 5 is a top view of an overall structure of the present disclosure.

FIG. 6 is a schematic diagram of swinging of inner mover and outer mover of the present disclosure.

FIG. 7 is an example diagram of a structure of magnetic poles of a magnet set of the present disclosure.

FIG. 8 is a first schematic diagram of swinging of a magnet set of the present disclosure.

FIG. 9 is a second schematic diagram of swinging of a magnet set of the present disclosure.

FIG. 10 is a first example diagram of magnetic effect of a mover assembly and a stator assembly of the present disclosure.

FIG. 11 is a second example diagram of magnetic effect of a mover assembly and a stator assembly of the present disclosure.

Reference numerals in the accompanying drawings: 1. bracket; 2. mover assembly; 21. inner mover; 211. inner swinging member; 2111. mounting column; 2112. first cylindrical hole; 212. inner magnetic yoke; 2121. first through hole; 213. inner swinging shaft; 22. outer mover; 221. outer magnetic yoke; 2211. third through hole; 222. outer swinging shaft; 23. annular frame; 231. first mounting column; 232. second cylindrical hole; 233. second mounting column; 24. magnet set; 241. first inner magnet; 242. second inner magnet; 243. first outer magnet; 244. second outer magnet; 25. elastic member; 26. first protrusion; 27. second protrusion; 3. stator assembly; 31. iron core; 32. coil; 33. coil frame; 4. limiting member; 41. opening, 42. limiting rod, 43. second through hole; 5. spring piece; 51. inner spring plate; and 52. outer spring plate.

### DESCRIPTION OF EMBODIMENTS

The technical solutions of embodiments of the present disclosure will be described below clearly and comprehensively in conjunction with accompanying drawings of the embodiments of the present disclosure.

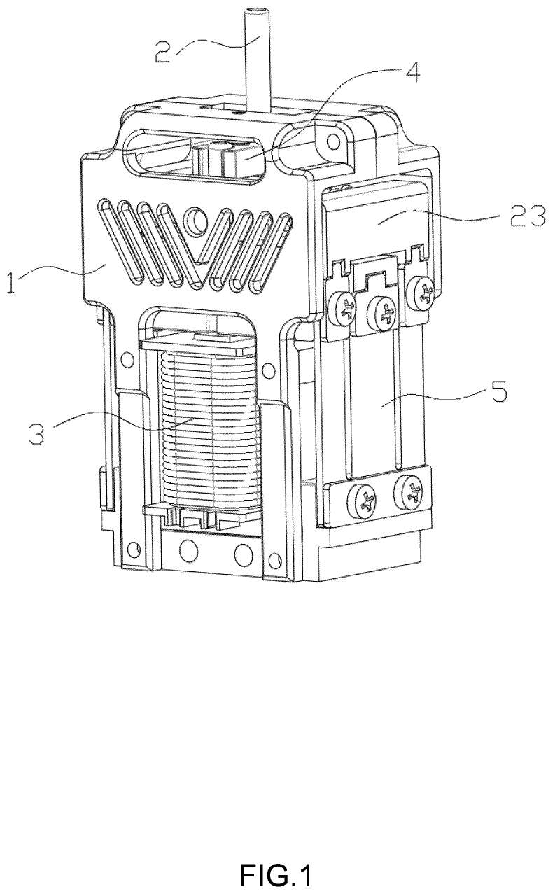

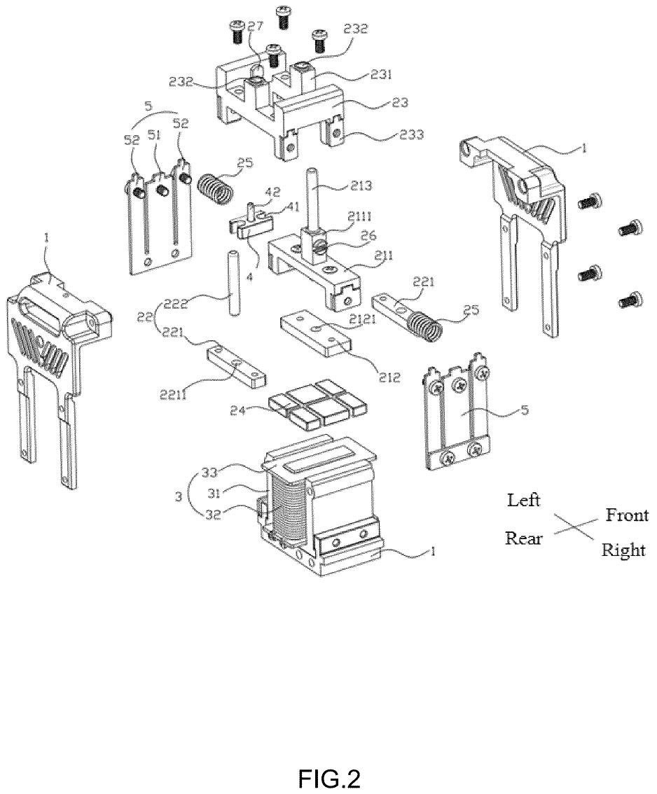

As shown in FIGS. 1-2, the present disclosure provides a three-mover linear motor, including a bracket 1, where a mover assembly 2 and a stator assembly 3 are arranged inside the bracket 1, and the mover assembly 2 is suspended above the stator assembly 3 and performs interlaced reciprocating motion driven by the stator assembly 3; the mover assembly 2 includes an inner mover 21 and outer movers 22 respectively arranged on both sides of the inner mover 21, an integrally die-cast annular frame 23 is connected between the two outer movers 22, the two outer movers 22 and the annular frame 23 are completely symmetrically arranged in front, rear, left, and right directions to ensure a balance of mass of the two outer movers 22 in front, rear, left, and right directions, thereby making it more stable; and the inner mover 21 moves back and forth in the annular frame 23, and a direction of motion of the inner mover is opposite to that of the annular frame 23. In the prior art, a motors with three movers is usually provided with a separate swinging frame for each of the movers, such that swinging of each mover is independent from one another and unaffected, which, however, will results in excessive parts inside the entire motor and a complex structure, being inconvenient for subsequent assembly and disassembly. In contrast, in the present disclosure, since the outer movers 22 on both sides of the inner mover 21 move in a same direction, the annular frame 23 is introduced to connect the two outer movers 22, the annular frame 23 is integrally die-cast and requires higher installation accuracy, thereby improving production qualification rate of the motor. In addition, reduction in a number of spare parts greatly improves the assembly efficiency. Furthermore, the annular frame 23 is provided with clearance structures around a perimeter thereof for the inner mover 21, such that the inner mover 21 can move freely in the annular frame 23 without interference from the annular frame 23.

Further, a limiting member 4 is connected between a central position above the inner mover 21 and a central position above any of the outer movers 22, and the way that the limiting member 4 is arranged at the central positions above the inner mover 21 and the outer movers 22 can further ensure balance and stability of the mover assembly 2 during reciprocating motion of the mover assembly; the limiting member 4 is movably and rotationally connected to an inner wall at a top of the bracket 1, and the limiting member 4 is located between the bracket 1 and the mover assembly 2, which is conducive to optimizing the performance of the mover assembly 2; at least one end of the limiting member 4 is provided with an opening 41, and the inner mover 21 or the outer movers 22 are rotationally connected in the opening 41. In the prior art, a swing limiter limiting the swinging of a mover is usually provided with through holes at both ends of the swing limiter, such that the inner mover 21 or the outer movers 22 is rotationally connected via the through holes, however, when the inner mover 21 and the outer movers 22 swing at a high speed, it is inevitable for them to pull and impact one another on the swing limiter, thereby generating a loud noise and poor user experience. Therefore, the limiting member 4 of the present disclosure is designed as a structure of the opening 41, such that the limiting member 4 has a better elastic efficient in a direction of motion, and impact generated by the inner mover 21 and the outer movers 22 during the motion can be absorbed, thereby reducing noise and extending a service life of the limiting member 4.

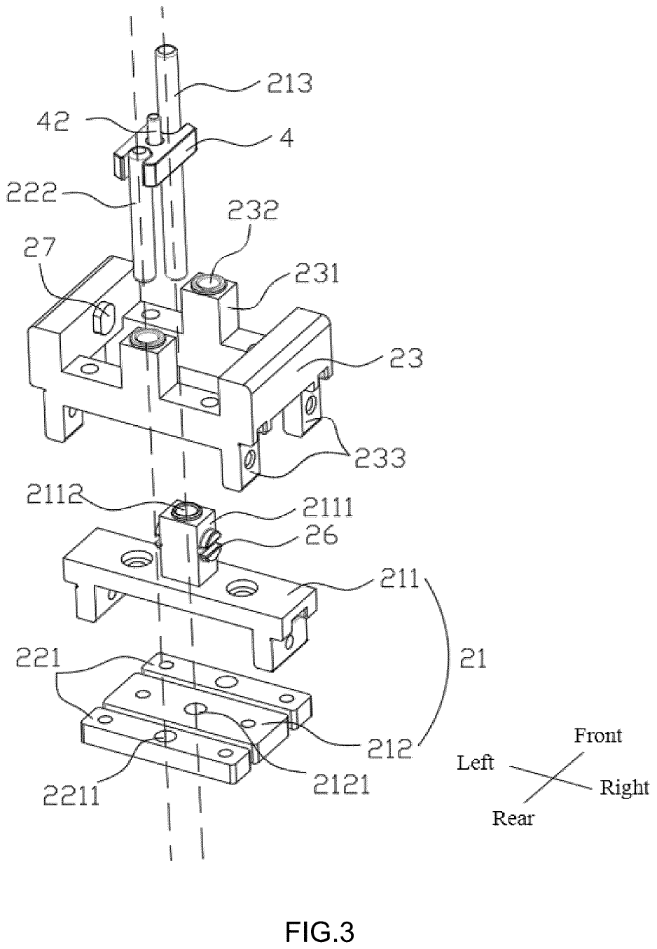

Specifically, as shown in FIG. 3, the inner mover 21 includes an inner swinging member 211 and an inner magnetic yoke 212 from top to bottom, an inner swinging shaft 213 is arranged on the inner swinging member 211, and the inner swinging shaft 213 penetrates through the inner swinging member 211 and the inner magnetic yoke 212 in sequence to achieve a fixed connection between them. The inner swinging member 211 has an “L” shaped structure that extends downward on both sides, and the inner magnetic yoke 212 is arranged inside the “L” shaped structure and fixedly connected to the inner swinging member 211, where a mounting column 2111 arranged in a middle of the inner swinging member 211, a first cylindrical hole 2112 that penetrates through the inner swinging member 211 is formed on the mounting column 2111, a first through hole 2121 that is communicated with the first cylindrical hole 2112 is formed on the inner magnetic yoke 212, and the inner swinging shaft 213 passes through the first cylindrical hole 2112 in sequence and is in interference-fit connection with the first through hole 2121 of the inner magnetic yoke 212, making the connection more stable and robust, and further, the swinging of the inner swinging shaft 213 can be directly driven by the inner magnetic yoke 212, improving swinging speed and accuracy.

Further, each of the outer movers 22 includes an outer magnetic yoke 221 and an outer swinging shaft 222 that are fixedly connected to the annular frame 23, the outer magnetic yoke 221 is fixed below the annular frame 23, a third through hole 2211 is formed on the outer magnetic yoke 221, a first mounting column 231 is arranged in a middle above front and rear crossbeams of the annular frame 23, a second cylindrical hole 232 that is communicated with the third through hole 2211 is formed inside the first mounting column 231, the outer swinging shaft 222 passes through the second cylindrical hole 232 and the third through hole 2211 in sequence and form an interference-fit connection, the outer magnetic yoke 221 drives the outer swinging shaft 222 to swing, and the annular frame 23 is driven to swing as a whole under the action of an electromagnetic field of the stator assembly 3, to ensure that swinging amplitudes of the outer movers 22 on both sides of the inner mover 21 are consistent, and further improving the swing accuracy of the inner mover 21.

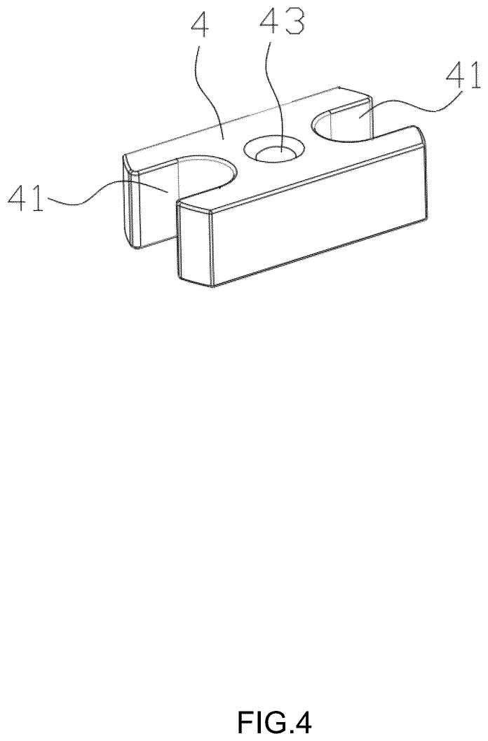

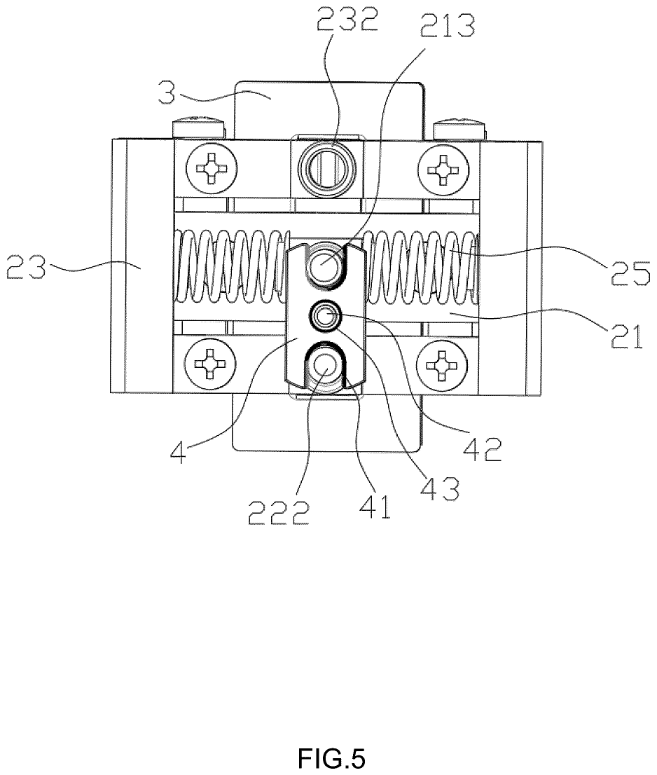

More further, as shown in FIGS. 4-6, in one embodiment of the present disclosure, both ends of the limiting member 4 are provided with openings 41, the outer swinging shaft 222 and the inner swinging shaft 213 are rotationally connected in the openings 41 respectively to limit a motion range of the mover assembly 2; and a position of the limiting member 4 corresponds to a position of the outer swinging shaft 222, the limiting member 4 is connected to the inner mover 21 and the outer movers 22 via the outer swinging shaft 222 and the inner swinging shaft 213, which also reduces a number of spare parts and avoiding the use of additional spare parts (such as bolts) as connectors, making an overall structure of the present disclosure more simpler and more practical.

Further, a second through hole 43 and a limiting rod 42 is arranged in a middle of the limiting member 4, one end of the limiting rod 42 passes through the second through hole 43 and is rotationally connected to the limiting member 4, and the other end thereof extends upward and is fixedly connected to the bracket 1, such that the limiting member 4 swings around the limiting rod 42 as a center, achieving connection between the inner mover 21 and the outer movers 22; and when the inner swinging shaft 213 swings to a right, one end of the limiting member 4 connected to the inner swinging shaft 213 also swings to the right, and the other end thereof swings to a left. Since swinging directions of the outer swinging shaft 222 and the inner swinging shaft 213 are opposite, the limiting member 4 delivers a boosting effect on the outer swinging shaft 222 and the annular frame 23.

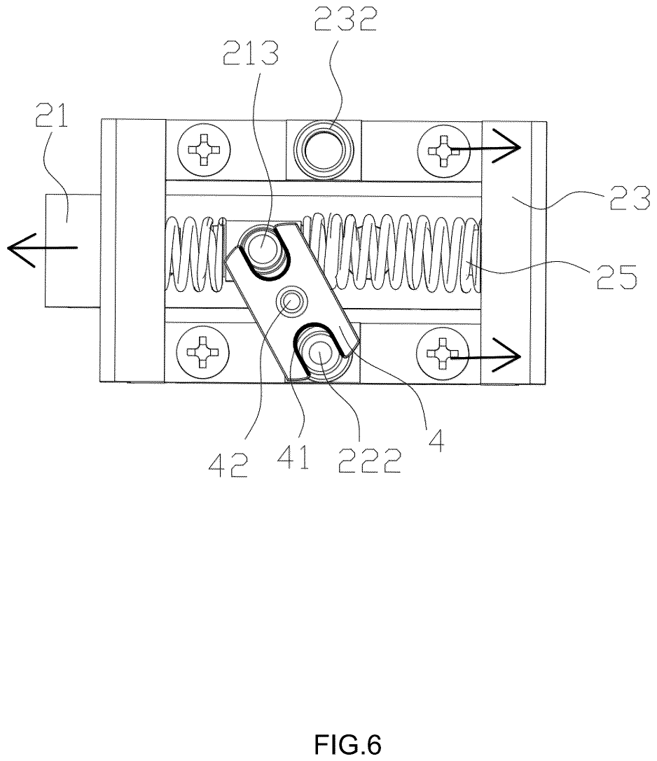

As shown in FIGS. 2 and 6, the mounting column 2111 of the inner swinging member 211 is provided with a first protrusion 26 on both sides in a direction of motion, two inner walls of the annular frame 23 opposite thereto are also provided with second protrusions 27, and one elastic member 25 is compressed between each pair of the first protrusion 26 and the second protrusion 27 that are opposite to each other. When the inner mover 21 swings to a right, the elastic member 25 on a right side is in a compressed state, while the elastic member 25 on a left side is in a stretched state. Since the elastic member 25 has restoring force, the restoring force also has boosting force on the swinging of the inner mover 21, and the inner swinging shaft 213 does not contact the annular frame 23 during swinging, avoiding noise and improving user experience. In addition, when the driving is stopped, the elastic member 25 has the effect of automatically resetting the inner swinging shaft 213.

More further, as shown in FIGS. 1 and 2, both sides of the outer mover 22 and the inner mover 21 are provided with spring pieces 5, and two spring pieces 5 are provided; where each of the spring pieces 5 includes an inner spring plate 51 and outer spring plates 52, the outer spring plates 52 are symmetrically arranged on both sides of the inner spring plate 51, an upper end of the inner spring plate 51 is fixedly connected to the inner swinging member 211 of the inner mover 21, second mounting columns 233 are arranged at two ends below left and right crossbeams of the annular frame 23, upper ends of the outer spring plates 52 are fixedly connected to the second mounting columns 233, and lower ends of the inner spring plate 51 and the outer spring plates 52 are integrally connected, and fixedly connected to a bottom of the bracket 1, such that the mover assembly 2 is suspended above the stator assembly 3. An integrated connection at lower ends of the spring pieces 5 is conducive to sheet formation, simplifies material control, fixes relative positions of the two spring pieces, and facilitates assembly and mass production.

It should be noted that both the first mounting column 231 and the second mounting column 232 protrude from the annular frame 23 to improve mounting efficiency, ensuring that the spare parts are tightly nested together and more stable; in addition, the first mounting column 231 and the second mounting column 232 are arranged perpendicularly to the corresponding crossbeams to facilitate demoulding and reduce processing, thereby improving production efficiency.

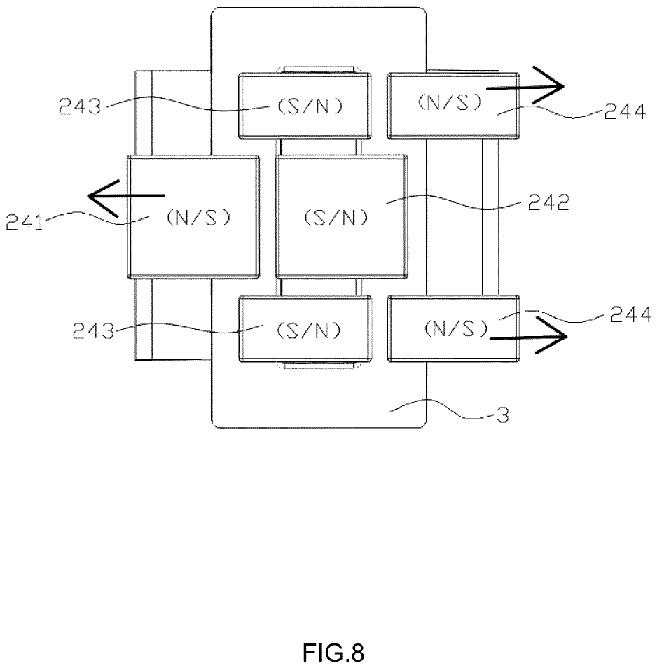

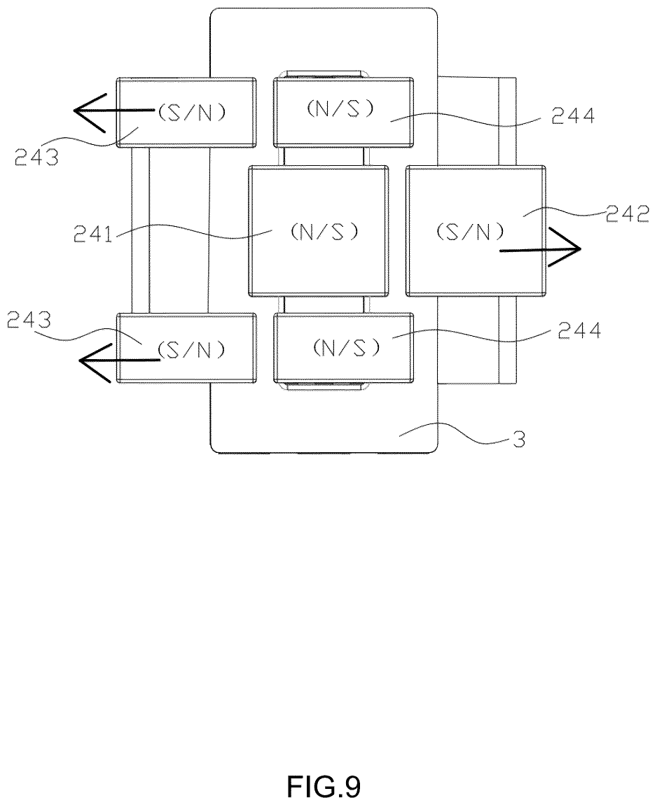

As shown in FIGS. 2 and 7-9, the mover assembly 2 further includes a magnet set 24, where the magnet set 24 includes a first inner magnet 241 and a second inner magnet 242 that are fixedly connected to the inner magnetic yoke 212 respectively, and a first outer magnet 243 and a second outer magnet 244 that are fixedly connected to the outer magnetic yoke 221 respectively, magnetic poles of the first inner magnet 241 and the first outer magnet 243 are opposite, magnetic poles of the second inner magnet 242 and the second outer magnet 244 are opposite, and magnetic poles at adjacent ends of the first inner magnet 241 and the second inner magnet 242 are opposite. When the stator assembly 3 is energized, a single magnetic field is formed at a certain moment at an upper end inside the stator assembly, the first inner magnet 241 and the second inner magnet 242 will swing to one side, and the first outer magnet 243 and the second outer magnet 244 swing to the other side according to the principles of magnet repulsion and attraction. As alternating current changes a direction, the magnetic field at the upper end of the stator assembly 3 also changes continuously, such that effect of continuous rapid interlaced swinging of the inner mover 21 and the outer movers 22 are realized.

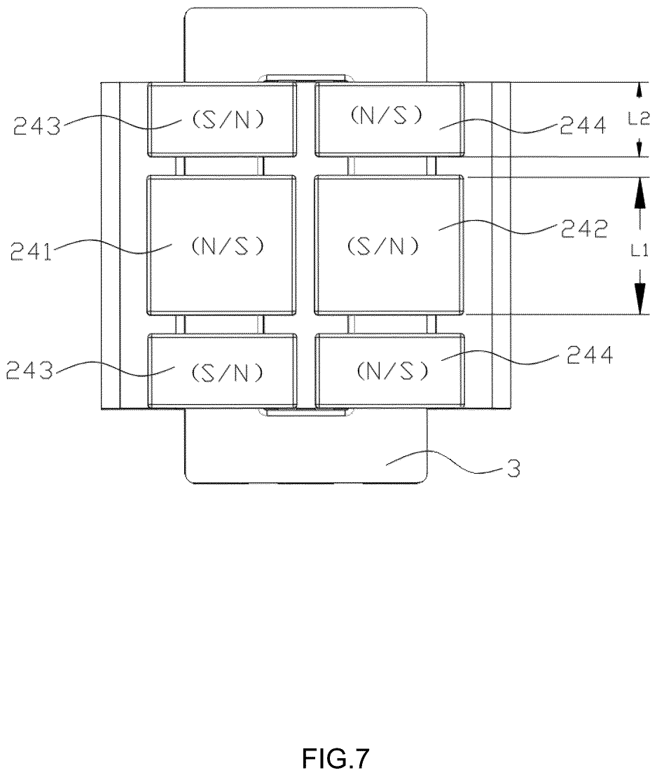

Preferably, as shown in FIG. 7, a width L2 of each of the outer movers 22 is less than or equal to a width L1 of the inner mover 21. Since the two outer movers 22 are connected by the annular frame 23, the annular frame 23 itself has a certain weight, the width L2 of each of the outer movers 22 should be designed to be less than or equal to ½ of the width L1 of the inner mover 21, so as to make the inner mover 21 and the outer movers 22 swing in a balanced manner and avoid lateral torsional vibration due to weight problems, Accordingly, a width L2 of the first outer magnet 243 or the second outer magnet 244 is also less than or equal to ½ of the width L1 of the first inner magnet 241 or the second inner magnet 242, such that the inner mover 21 has more driving force than the outer movers 22, thereby balancing the swinging between them and improving user experience.

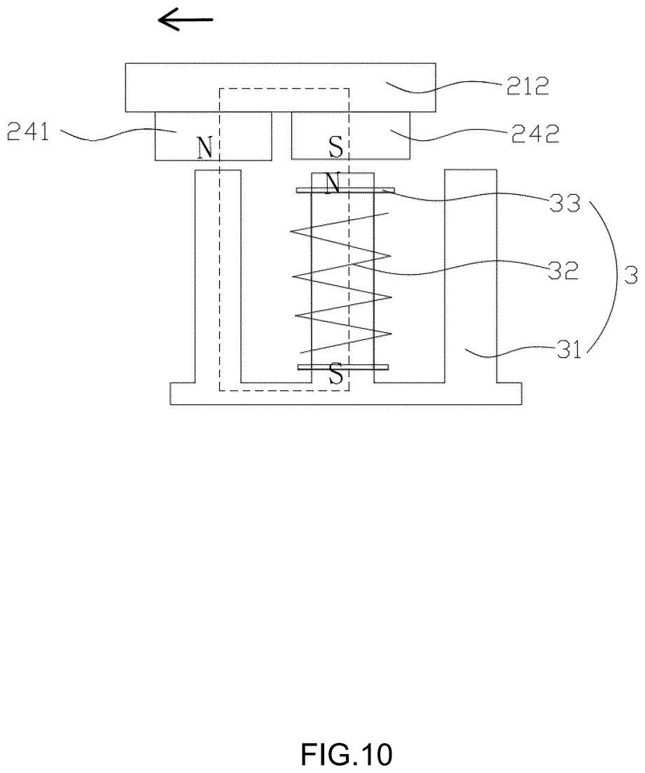

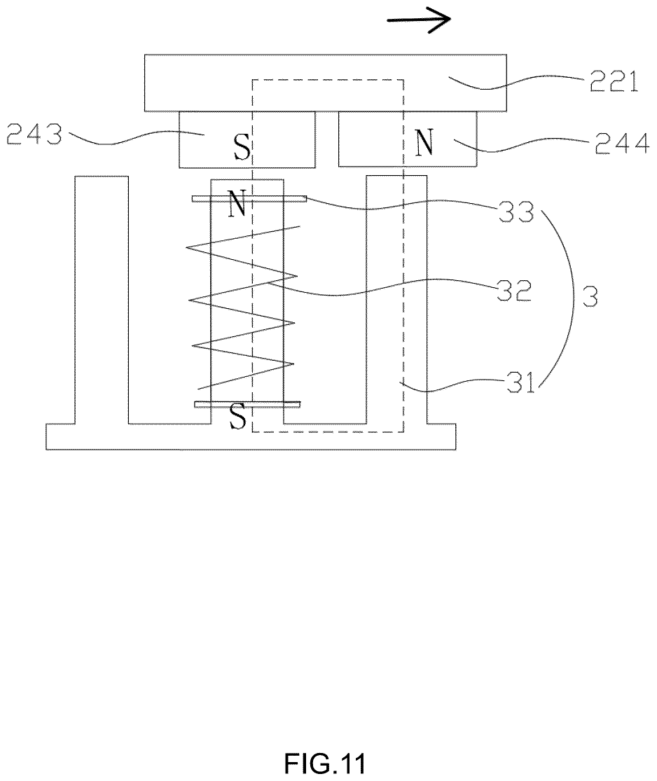

Preferably, as shown in FIGS. 10-11, the stator assembly 3 includes an iron core 31, a coil 32, and a coil frame 33, where the iron core 31 is arranged in an inverted E-shape and is screwed to the bracket 1 on both sides, the coil frame 33 is sleeved over a middle part of the iron core 31, and the coil 32 is wound around the coil frame 33. When the coil 32 is energized, a magnetic effect of current causes the coil 32 and the iron core 31 to generate an induced magnetic field together, such that the inner magnetic yoke 212 and the outer magnetic yoke 221 located above the stator assembly 3 perform opposite reciprocating motions.

In addition, it should be understood that although the description is described according to implementations, each implementation does not include only one independent technical solution, the description is for clarity only, and those skilled in the art should take the description as a whole, the technical solutions in the various embodiments may be appropriately combined to form other implementations understandable by those skilled in the art.

For those skilled in the art, it is apparent that the present disclosure is not limited to details of the exemplary embodiments, and the present disclosure can be implemented in other specific forms without departing from the spirit or basic features of the present disclosure. Therefore, the embodiments should be regarded as illustrative and non-restrictive no matter from which point of view. The scope of the present disclosure is defined by the appended claims rather than the above specification, and therefore, it is intended that all changes which fall within the meaning and scope of equivalency of the claims are embraced in the present disclosure. Any reference numeral in the claims should not be construed as limiting the related claims.

What is claimed is:

1. A three-mover linear motor, comprising a bracket, wherein a mover assembly and a stator assembly are arranged inside the bracket, and the mover assembly is suspended above the stator assembly and performs interlaced reciprocating motion driven by the stator assembly; and the mover assembly comprises an inner mover and outer movers respectively arranged on both sides of the inner mover, an integrally die-cast annular frame is connected between the two outer movers, the two outer movers and the annular frame are completely symmetrically arranged in front, rear, left, and right directions, and the inner mover moves back and forth in the annular frame, and a direction of motion of the inner mover is opposite to that of the annular frame; wherein
a limiting member is connected between a central position above the inner mover and a central position above any of the outer movers, the limiting member is movably and rotationally connected to an inner wall at a top of the bracket, and the limiting member is located between the bracket and the mover assembly; and
the inner mover comprises an inner swinging member and an inner magnetic yoke from top to bottom, an inner swinging shaft is arranged on the inner swinging member, and the inner swinging shaft penetrates through the inner swinging member and the inner magnetic yoke in sequence to achieve a fixed connection between them.

2. The three-mover linear motor according to claim 1, wherein each of the outer movers comprises an outer magnetic yoke and an outer swinging shaft that are fixedly connected to the annular frame, a third through hole is formed on the outer magnetic yoke, a first mounting column is arranged in a middle above front and rear crossbeams of the annular frame, a second cylindrical hole is formed inside the first mounting column, and the outer swinging shaft passes through the second cylindrical hole and the third through hole in sequence.

3. The three-mover linear motor according to claim 2, wherein both ends of the limiting member are provided with openings, and the outer swinging shaft and the inner swinging shaft are rotationally connected in the openings, respectively.

4. The three-mover linear motor according to claim 3, wherein a limiting rod is arranged in a middle of the limiting member, one end of the limiting rod is rotationally connected to the limiting member, and the other end thereof extends upward and is fixedly connected to the bracket.

5. The three-mover linear motor according to claim 4, wherein the mover assembly further comprises a magnet set, the magnet set comprises a first inner magnet and a second inner magnet that are fixedly connected to the inner magnetic yoke respectively, and a first outer magnet and a second outer magnet that are fixedly connected to the outer magnetic yoke respectively, magnetic poles of the first inner magnet and the first outer magnet are opposite, and magnetic poles of the second inner magnet and the second outer magnet are opposite.

6. The three-mover linear motor according to claim 1, wherein elastic members are compressed between two sides of the inner swinging member in a direction of motion and inner walls of the annular frame.

7. The three-mover linear motor according to claim 1, wherein both sides of the outer movers and the inner mover are provided with spring pieces, and two spring pieces are provided; each of the spring pieces comprises an inner spring plate and outer spring plates, and an upper end of the inner spring plate is fixedly connected to the inner mover; and second mounting columns are arranged at two ends below left and right crossbeams of the annular frame, upper ends of the outer spring plates are fixedly connected to the second mounting columns, and lower ends of the inner spring plate and the outer spring plates are fixedly connected to the bracket.

8. The three-mover linear motor according to claim 1, wherein a width of each of the outer movers is less than or equal to a width of the inner mover.

9. The three-mover linear motor according to claim 1, wherein the stator assembly comprises an iron core, a coil, and a coil frame; wherein the iron core is arranged in an inverted E-shape and is screwed to the bracket on both sides, the coil frame is sleeved over a middle part of the iron core, and the coil is wound around the coil frame.
